(19) United States
(12) Patent Application Publication
(10) Pub. No.: US 2011/0200846 A1
(43) Pub. Date: Aug. 18, 2011

(54) METHOD OF MANUFACTURING A MAGNETIC RECORDING MEDIUM HAVING A DISCRETE TRACK STRUCTURE

(75) Inventor: Hitoshi NAKATA, Kawasaki-shi (JP)

(73) Assignee: Fuji Electric Device Technology Co., Ltd., Tokyo (JP)

(21) Appl. No.: 12/876,428

(22) Filed: Sep. 7, 2010

(30) Foreign Application Priority Data
Feb. 16, 2010 (JP) JP PA 2010-031499

(51) Int. Cl. G11B 5/706; C25D 11/04

(52) U.S. Cl. 428/848.5; 205/199

(57) ABSTRACT

A method of manufacturing a magnetic recording medium having a discrete track structure enables the discrete track structure to be fabricated in a simple method with good productivity while maintaining satisfactory accuracy of the discrete track structure and holding favorable magnetic separation performance between tracks. The method comprises steps of: forming an aluminum film on a nonmagnetic substrate; executing an anodizing process on the aluminum film to form an alumina layer including nano-holes in a self-organizing manner; forming a resist pattern exposing recording track regions; and depositing a magnetic material in the nano-holes in the recording track regions. The method can further comprise a step of forming recessed parts at positions of the nano-holes to be formed in the anodizing process. The method can further comprise a step of forming a first underlayer of titanium and a second underlayer of gold.

### CROSS-REFERENCE TO RELATED APPLICATION

This application claims priority under 35 U.S.C. §119 from Japanese Patent Application 2010-031499, filed Feb. 16, 2010, the entirety of which is incorporated herein by reference.

### BACKGROUND OF THE INVENTION

1. Field of the Invention

The present invention relates to a method of manufacturing a magnetic recording medium, in particular to a method of manufacturing a magnetic recording medium in which a discrete track structure is formed by arranging nano-holes in a recording track.

2. Description of the Related Art

A variety of efforts has been made for enhancing a recording density of a magnetic recording medium. Among the efforts, a discrete track medium (also abbreviated to DTM in the following description) has been proposed to increase a track density and enhance a recording density. In the DTM, a structure of protrusions and recesses is formed along a track on a recording surface to reduce magnetic interference between the tracks.

Various techniques have been proposed for manufacturing the DTM. In one of such techniques, a pattern of protrusions and recesses is formed on a resist and then, using the pattern configuration of the resist as a mask, the magnetic layer is partially removed by an etching process, for example, to produce magnetic separation along the track direction. As needed, a protective layer is deposited and the recessed parts are filled in.

Japanese Unexamined Patent Application Publication No. H04-310621 discloses a magnetic recording medium having a high permeability layer and a magnetic layer on a substrate in which a part lacking both the high permeability layer and the magnetic layer is provided between recording tracks for recording and reproduction, thereby surely avoiding mixing of recording signals between adjacent recording tracks in a reproduction process.

Japanese Unexamined Patent Application Publication No. 2006-012285 discloses a magnetic recording medium comprising a substrate, a soft magnetic layer formed on the substrate, and a magnetic layer that is formed on the soft magnetic layer through an intermediate layer and divided into a multiple of recording elements with a prescribed pattern of protrusions and recesses. The means of Japanese Unexamined Patent Application Publication No. 2006-012285, according to assertion by the inventors thereof, avoids cross-talk to an adjacent track in a recording and reproducing process and prevents degradation of the recording and reproducing performance due to provision of the pattern of protrusions and recesses.

Japanese Unexamined Patent Application Publication No. 2006-012285 discloses a method that comprises a step of applying a resist on a magnetic layer formed on a nonmagnetic substrate, a step of patterning to form a mask, and a step of implanting ions into the magnetic film corresponding to exposed places of the mask for modifying a magnetic property thereby forming magnetically separated parts.

The DTM of the above-described method uses a starting article of an ordinary magnetic recording medium. The DTM is formed, as usual, by forming layers including at least a magnetic layer formed on a nonmagnetic substrate of glass or aluminum, and a mask pattern is formed thereon. The method is favorable because it allows an ordinary magnetic recording medium to be used for a starting article.

The DTMs as described above performs magnetic separation between tracks by physically etching the magnetic recording layer. However, a magnetic recording medium generally achieves desired magnetic characteristics by laminating multiple of layers including a seed layer, an orientation control layer, and a soft magnetic backing layer under the magnetic recording layer. A depth of the etching process must be controlled in an order of a nanometer, corresponding to a thickness of a layer to be separated, not only in the case of separating solely the magnetic recording layer, but also in the case of separating simultaneously a part of an underlying layer. This control is a very difficult task.

In addition, it is still difficult to form a mask pattern itself on a magnetic recording medium. A patterning method employing photolithography, for example, although advantageous in view of throughput owing to whole surface exposure, is accompanied by difficulty in exposing the whole surface with a large area of a magnetic disk with a fine pattern of ten and several nanometers. A fine pattern of ten and several nanometers can be formed by an electron beam lithography method and a focused ion beam lithography method, in which the electron beam or a focused ion beam is emitted along the pattern. However, it would take several days to completely process the whole surface of such a large area of a magnetic disk medium. Thus, those methods are not practical in consideration of escalated cost due to increased processing time.

### SUMMARY OF THE INVENTION

In view of the above-described problems, it is an object of the present invention to provide a method of manufacturing a magnetic recording medium having a discrete track structure in a simple way and with good productivity while maintaining a satisfactory accuracy of the discrete track structure and good magnetic separation performance between tracks.

In order to solve the problems described above, according to embodiments of the present invention a discrete track structure is formed utilizing self-organization of nano-holes. More specifically, a method of manufacturing a magnetic recording medium having a discrete track structure provided with a magnetic recording layer on a nonmagnetic substrate comprises steps of (a) forming an aluminum film on the nonmagnetic substrate; (b) executing an anodizing process on the aluminum film while applying a voltage to form an alumina layer including nano-holes; (c) applying a resist material on the alumina layer; (d) removing the resist material on recording track regions of discrete tracks; (e) depositing a magnetic material in the nano-holes in the recording track regions; and (f) removing remaining resist material, the steps being conducted in this order.

The method can further comprise a step of sealing the exposed nano-holes after step (f).

The method can further comprise, between step (a) and step (b), a step of forming recessed parts at positions of the nano-holes to be formed in step (b). The step of forming recessed parts at positions of the nano-holes to be formed in step (b) can be carried out by means of a nano-imprinting method.

Step (d) can include a process of patterning the recording track regions by means of a nano-imprinting method.

The process of step (d) can include a step of patterning the recording track regions by means of an electron beam drawing method.

The method can further comprise, before step (a), a step of forming a first underlayer comprising titanium and a second underlayer comprising gold on the nonmagnetic substrate, in this order.

Expressed in other terms, embodiments of the invention relate to a method that can comprise forming a film on a substrate, processing the film to form a layer including nano-holes, and applying a resist material to the layer. The method can further comprise removing the resist material to expose nano-holes in a region to be used as a recording track region of a discrete track of a recording medium, depositing a magnetic material in the exposed nano-holes, and removing remaining resist material from the layer.

According to the method, the processing the film can comprise anodizing the film while applying a voltage. Further, the processing the film can comprise imprinting the film with recesses corresponding to the nano-holes to be formed. The method can further comprise patterning the recording track region using nano-imprinting. Additionally or alternatively, the method can further comprise patterning the recording track region using electron beam lithography. The method can still further comprise, before forming the film on the substrate, forming on the substrate a first underlayer comprising titanium and a second underlayer comprising gold.

Embodiments of the invention can further relate to a magnetic recording medium. The magnetic recording medium can comprise a non-magnetic substrate, an underlayer formed on the non-magnetic substrate, and a magnetic recording layer formed on the underlayer, the magnetic recording layer including nano-holes corresponding to a recording track region of a discrete track of the magnetic recording medium. The nano-holes corresponding to a recording track region can be filled with a magnetic material and separated from each other by a non-magnetic layer and sealed nano-holes.

By means of the acts and structures as specified above, a discrete track structure can be formed solely in a magnetic recording layer without affecting layers disposed under the magnetic recording layer. The discrete track structure is formed in the method of the invention in high accuracy and maintaining a good magnetic separation performance over such a large area as of a magnetic recording medium. A magnetic recording layer fabricated according to the invention, irrespective of having a discrete track structure, has a substantially flat surface. Moreover, the invention provides a method for fabricating a discrete track structure in a simple way and with an excellent productivity.

### BRIEF DESCRIPTION OF THE DRAWINGS

FIGS. 1A through 1F are schematic sectional views of a part of a magnetic recording medium for illustrating the first aspect of embodiment of the present invention to fabricate a discrete track structure;

FIGS. 2A through 2E are schematic sectional views of a part of a magnetic recording medium for illustrating the third aspect of embodiment of the present invention to fabricate a discrete track structure;

FIG. 3 is a schematic sectional view for illustrating an example of magnetic recording medium manufactured according to the present invention; and

FIG. 4 is a top plan view for illustrating an example of magnetic recording medium manufactured according to the present invention.

### DETAILED DESCRIPTION OF THE INVENTION

In the following, non-limiting embodiments according to the present invention will be described in detail with reference to accompanying drawings.

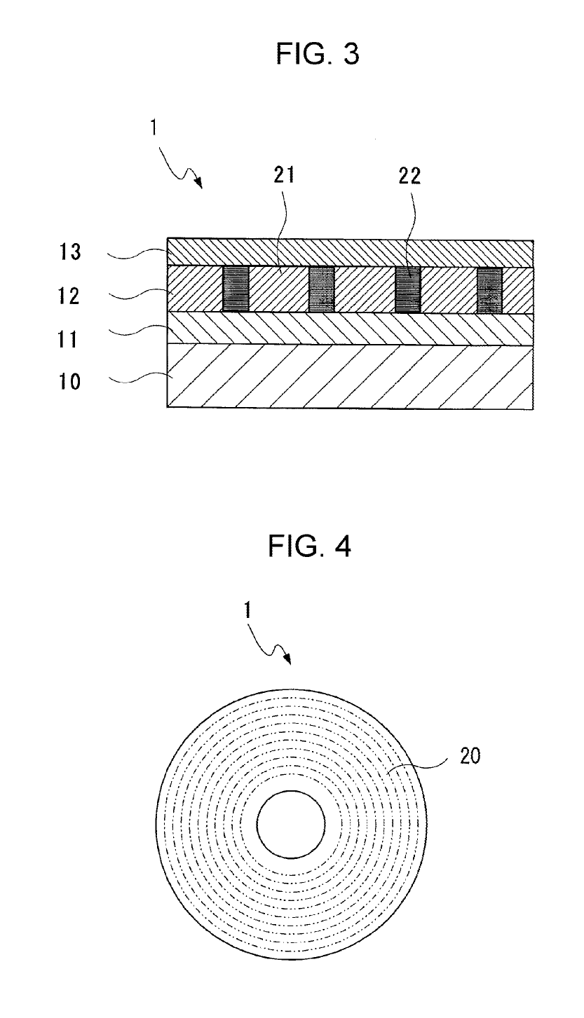

FIGS. 3 and 4 are drawings for illustrating an example of magnetic recording medium manufactured by a method of the present invention, in which FIG. 3 is a schematic sectional view and FIG. 4 is a top plan view. Referring to FIG. 3, a magnetic recording medium 1 comprises an underlayer 11, a magnetic recording layer 12, and a protecting and lubricating layer 13 all formed on a nonmagnetic substrate 10. The magnetic recording layer 12 comprises an alumina layer 21 and magnetic material parts 22. The magnetic material parts 22 perform a data recording function in a discrete track medium, and are formed with a magnetic material embedded in small holes of an approximately cylindrical shape. Recording tracks 20 for data recording are formed in concentric circles as shown in FIG. 4, and the magnetic material parts 22 with an approximately cylindrical shape are arranged scattering, e.g., arranged in a scattered fashion, in the recording tracks. The alumina layer 21 acts to provide magnetic separation between the magnetic material parts 22 and magnetic separation between recording tracks.

<First Aspect of Embodiment>

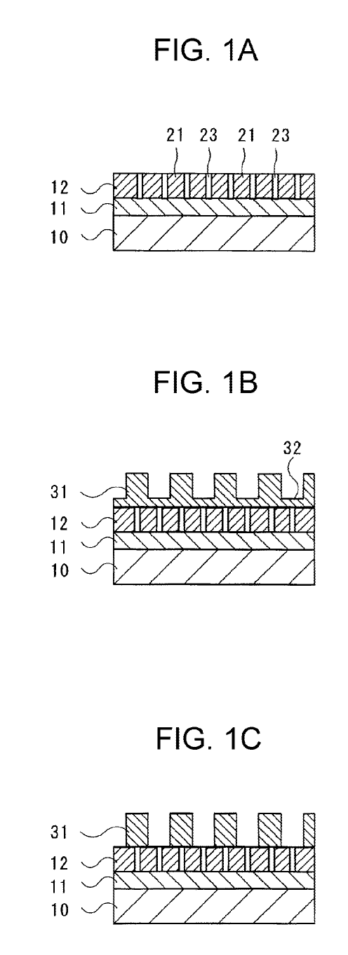

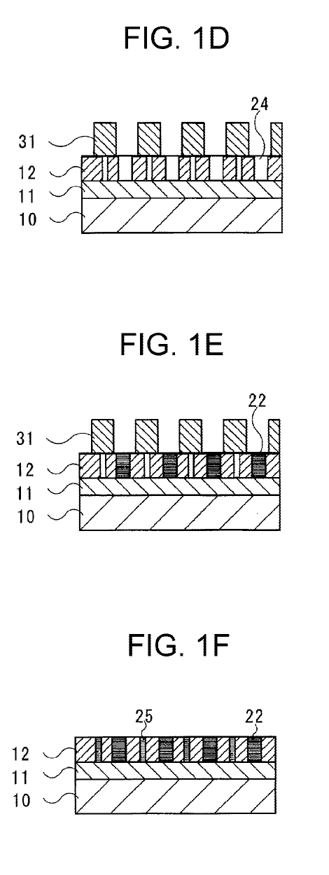

FIGS. 1A through 1F are schematic sectional views of a part of a magnetic recording medium for illustrating the first aspect of embodiment to fabricate a discrete track structure. FIG. 1A shows a state in which an alumina layer 21 including nano-holes 23 is formed after depositing an underlayer 11 on a nonmagnetic substrate 10 by a sputtering method or the like. The nano-holes 23 are formed in the following way, for example. First, an aluminum film is deposited on the underlayer 11 by a sputtering method or the like. Subsequently, an anodization process is conducted with application of an electric field in an oxalic acid solution and the like; thereby, nano-holes are regularly formed at an interval corresponding to the applied voltage in a self-organizing manner. The anodization process transforms the aluminum film to an alumina layer 21 including the nano-holes 23. A thickness of the formed aluminum layer is optionally at most 100 nm. A useful solution for the anodization process can be oxalic acid. An interval of the nano-holes equivalent or smaller than a pitch of discrete tracks to be fabricated ensures formation of magnetic material parts 22 in each track.

Subsequently, as shown in FIG. 1B, a pattern is formed on the alumina layer 21 using a resist material. The pattern can be formed by means of a nano-imprinting method. An original master disk for use in the nano-imprinting is prepared in advance with protrusions and recesses corresponding to the configuration of desired discrete tracks. The original master disk is pushed against the resist material 31 with a prescribed pressure to transfer the pattern of protrusions and recesses. Remaining films 32 of the resist material usually exist at the places corresponding to the protruding parts of the original master disk.

The original master disk is fabricated for example in the following way.

First, a chromium film is formed on quartz glass, and on the chromium film, a resist for electron beam lithography is applied. Subsequently, an electron beam drawing process executes an exposure process on the resist material in a pattern of the discrete track configuration, and then, a development process is conducted to form a resist pattern. Subsequently, the chromium film is patterned by means of an etching process or the like. Subsequently, using the chromium film as a mask, the quartz glass is machined in a prescribed pattern by a dry etching process producing a quartz master disk. In order to ensure easy releasing in the nano-imprinting process, the surface of the quartz master disk can be coated with a fluorine-containing release agent. Even when a master disk is fabricated by means of a time-consuming method of electron beam drawing, the master disk itself being used repeatedly, productivity of magnetic recording media is scarcely affected.

Subsequently as shown in FIG. 1C, the remaining films 32 of the resist material left on the bottom of the pattern formed in the nano-imprinting process are removed by a reactive ion etching method using CF4 gas.

Subsequently as shown in FIG. 1D, a phosphoric acid etching process is conducted at the exposed nano-holes to form nano-holes 24 with an expanded diameter.

Then as shown in FIG. 1E, the exposed nano-holes are filled with a magnetic material to form magnetic material parts 22. Since the nano-holes have a large aspect ratio, the magnetic material parts 22 can be formed by an electroplating method. As a matter of course, commonly used dry deposition methods such as a sputtering method and a CVD method can be used as well. Useful magnetic material can be selected from magnetic materials commonly used in the art including cobalt-based alloys of CoCr alloy, CoCrPt alloy, and CoCrPtTa alloy; rare earth-transition metal alloy; and these alloys with an additive of an oxide or nitride.

At the protruding parts of the resist material, the nano-holes 23 under the resist material are shielded and remained without deposition of the magnetic material. Thus, recording track regions for magnetic recording are formed at the places of exposed nano-holes along the pattern of the resist material 31. As described afterwards, the protruding region of the resist material serves as a magnetic separation region between recording tracks.

As can be seen from the above description, the recording track region is determined according to the pattern of resist material 31. Consequently, the recording track region is not influenced by the step of forming nano-holes shown in FIG. 1A and can be formed at any desired position irrespective of arrangement of the initial nano-holes.

Subsequently as shown in FIG. 1F, the resist material 31 is removed and then, the nano-holes 25 under the resist material are filled by a sealing process, completing a procedure for forming a magnetic recording layer.

On the magnetic recording layer 12, a protecting and lubricating layer 13 may be formed for the purpose of protection of a magnetic recording medium and lubrication with a magnetic head. This layer can be formed in a single layer, or in a laminated layer of function-separated plural layers. A protective layer can be formed of a film known in the art including carbon films of amorphous carbon, diamond-like carbon, and tetrahedral carbon, and a silicon film. A lubricating layer can be a film known in the art including a perfluoropolyether film.

The initial nano-holes 23 shown in FIG. 1A are either filled with a magnetic material or sealed as described previously and thus, the surface of the magnetic recording layer 12 is formed to be substantially flat. As a result, a protective layer and a lubricating layer formed on the flat surface can be formed maintaining good adhesiveness and corrosion resistance. Therefore, a magnetic recording medium exhibits enhanced reliability.

For a nonmagnetic substrate 10, any material with rigidity and flatness can be used, including substrates used in ordinary magnetic recording medium of a NiP-plated aluminum alloy substrate, a glass substrate of strengthened glass or crystallized glass, and a silicon substrate. If a substrate heating temperature can be held within 100° C., a plastic substrate composed of a resin of polycarbonate or polyolefin can also be used.

The underlayer 11 is provided in order to favorably deposit an aluminum film to be deposited in the following step. The underlayer can be a single layer or a plurality of layers. For example, a favorable laminated layer comprises or consists of the first layer for enhancing adhesiveness with the nonmagnetic substrate 10 and the second layer for improving deposition performance of an aluminum film. The first layer can be formed of titanium or chromium, and the second layer can be formed of a noble metal such as platinum, gold or ruthenium. The second layer formed of these materials exhibits electric conductivity and improved corrosion resistance. In addition, a soft magnetic film comprising an alloy containing cobalt, iron and nickel can be provided between the first layer and the second layer for improving recording and reproducing performance.

<Second Aspect of Embodiment>

In the second aspect of embodiment of the present invention, the nano-holes 23 are formed in an aluminum film at the places where recessed parts are preliminarily formed.

An original master disk is fabricated in advance having protruding parts at the positions corresponding to nano-holes to be formed. The original master disk is pushed against the aluminum film before the anodizing process shown in FIG. 1A, to form minute recessed parts on the aluminum film. The anodization process is conducted adjusting an applied voltage to match the interval of the minute recessed parts, thereby forming nano-holes at the minute recessed parts. The original master disk in this embodiment can be fabricated in the same manner as in fabrication of the original master disk for the discrete track described previously.

After that, the steps of FIG. 1B through FIG. 1F are executed in the same manner as in the first aspect of embodiment, to form desired discrete track regions.

In this aspect of embodiment, the nano-holes 23 are formed at the positions of the discrete track regions to be formed, preventing the nano-holes 23 from being formed extending in both the recording track regions and the magnetic separation regions. Consequently, the recorded signals are held at a good signal-to-noise ratio.

Giving a supplementary explanation, when the nano-holes are formed by an anodizing process in the self-organizing manner, the nano-holes can be formed at the interval corresponding to the applied voltage. Even if the minute recessed parts are not formed in the magnetic separation region between the discrete tracks, nano-holes are still formed in the magnetic separation region at the interval corresponding to the applied voltage. Therefore, a post step is needed for forming recording tracks by filling selected parts of the nano-holes with a magnetic material.

<Third Aspect of Embodiment>

In this third aspect of embodiment, a method of forming a pattern in the resist material 31 is altered.

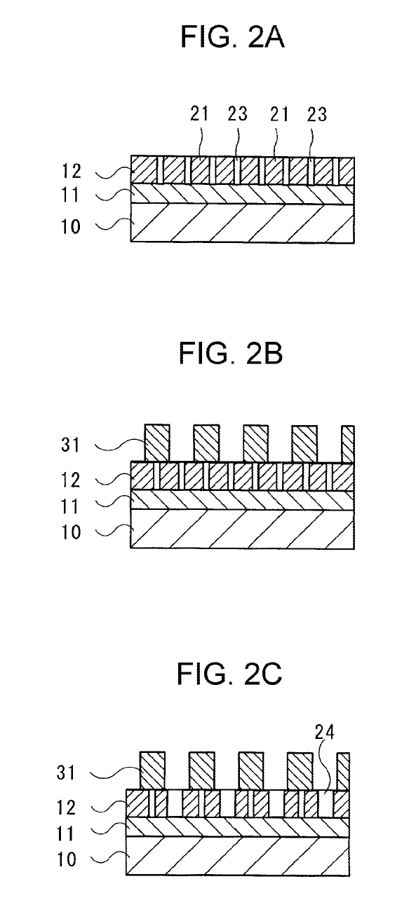

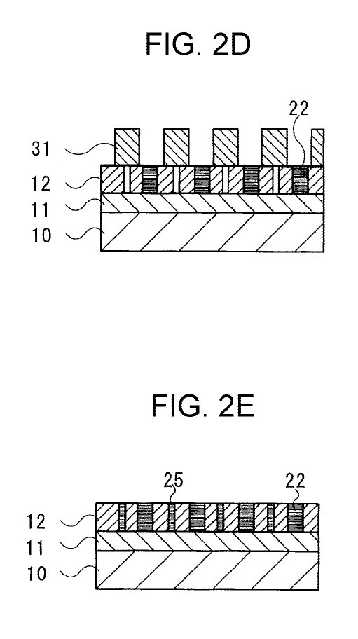

FIGS. 2A through 2E are schematic sectional views of a part of a magnetic recording medium illustrating the third aspect of embodiment according to the present invention for fabricating a discrete track structure. FIG. 2A shows a state in which an alumina layer 21 including nano-holes 23 is formed after depositing an underlayer 11 on a nonmagnetic substrate 10 by a sputtering method or the like. The nano-holes are formed in the same manner as in the second aspect of embodiment.

Subsequently as shown in FIG. 2B, a pattern of resist material is formed on the alumina layer 21. The pattern can be formed by means of an electron beam drawing method. After applying a resist material for electron beam drawing on the alumina layer 21, an exposure process is conducted by irradiating the resist with an electron beam in concentric circles, and then through a development process, a pattern is formed corresponding to the discrete track configuration. In the case of electron beam drawing, a remaining film of the resist material is generally so slight that a step for removing the remaining film can be omitted.

After that, the steps of FIG. 2C through FIG. 2E are executed in the same manner as in the first aspect of embodiment to form a discrete track region. The steps of FIGS. 2C through 2E correspond to the steps of FIG. 1D through FIG. 1F, respectively.

The third aspect of embodiment, which employs an electron beam drawing method, takes a longer time for executing the procedure than the first aspect of embodiment. However, the third aspect of embodiment has an advantage, like the first aspect of embodiment, that a magnetic separation region between discrete tracks can be formed without taking a scattering in accuracy of an etching depth into consideration.

<Fourth Aspect of Embodiment>

In this fourth aspect of embodiment, the nano-holes 23 are formed in an aluminum film at the places where recessed parts are preliminarily formed.

As in the second aspect of embodiment, an original master disk is fabricated in advance having protruding parts at the positions corresponding to nano-holes to be formed. The original master disk is pushed against the aluminum film before the anodization process shown in FIG. 2A to form minute recessed parts on the aluminum film.

After that, the steps of FIG. 2B through FIG. 2E are executed in the same manner as in the third aspect of embodiment, to form desired discrete track regions.

Although omitted in the description on the aspects of embodiment thus far, other layers exhibiting various functions that are employed in ordinary magnetic recording media can be provided to improve performance of a magnetic recording medium. Some examples of such layers are described in the following.

A soft magnetic backing layer can be provided for controlling a magnetic flux from a magnetic head used in magnetic recording and improving recording and reproduction performance. The soft magnetic backing layer is effective for perpendicular magnetic recording in particular. A soft magnetic backing layer can be formed using crystalline alloy of a NiFe alloy, a sendust alloy (FeSiAl alloy), and a CoFe alloy; micro crystalline alloys of FeTaC, CoTaZr, CoFeNi, and CoNiP can also be used. Amorphous cobalt alloys for example, CoNbZr and CoTaZr provide superior electromagnetic conversion characteristics. The optimum thickness of the soft magnetic backing layer varies depending on a structure and characteristics of a magnetic head used for magnetic recording. In the case where the soft magnetic layer is formed by successive deposition with other layers, a desirable thickness is in the range of 10 nm to 500 nm in consideration of balance with productivity. In the case where the soft magnetic layer is formed on a nonmagnetic substrate prior to deposition of other layers, by means of a plating method or the like, a thickness at a large value of several microns is possible.

A magnetic domain control layer can be provided when a soft magnetic backing layer is employed, for the purpose of controlling magnetic domains of the soft magnetic backing layer and suppressing spike noise and other noises caused by the soft magnetic backing layer. Useful materials for the magnetic domain control layer include an anti-ferromagnetic film of a manganese-containing alloy such as PtMn or IrMn, and a hard magnetic film of CoCrTa, CoCrPt, or CoCrPtB with the magnetization thereof oriented in the radial direction of a nonmagnetic substrate 10. A thickness of the magnetic domain control layer can be in the range of 5 to 300 nm. In addition, provision of an intermediate layer is a favorable selection for ensuring crystallinity of the magnetic recording layer.

The present invention will be described further in detail referring to some illustrative specific examples in the following. In the following description, a phrase “a substrate under-process” is commonly used for any nonmagnetic substrates having a layer(s) formed thereon in the process of manufacturing a magnetic recording medium.

### Example 1

This example is based on the first aspect of embodiment and described referring to FIGS. 1A through 1F.

A silicon substrate was used for a nonmagnetic substrate 10. After cleaning thoroughly, the substrate was introduced into a sputtering apparatus and an underlayer 11 composed of two layers was deposited. The first underlayer of a titanium film 50 nm thick was deposited and subsequently the second underlayer of a gold film 60 nm thick was deposited. Then, a magnetic recording layer 12 was formed as described in the following. First, an aluminum film 100 nm thick was deposited by a sputtering method. Subsequently, the substrate under-process was extracted from the sputtering apparatus and transferred into an anodizing apparatus. Anodization of the aluminum film was executed in an oxalic acid solution with a concentration of 0.3 molar % at an anodizing voltage of 2.5 V to form nano-holes 23 in a self-organizing manner. Through the anodization process, the metallic aluminum becomes an oxide, alumina. The formed nano-holes (FIG. 1A) had an interval of 12 nm and a diameter of 4 nm. Then, a resist material 31 of spin-on glass was applied on the alumina layer 21. A thickness of the resist was 40 nm. A pattern of protrusions and recesses was formed in concentric circles on the resist material 31 by a nano-imprinting method. An original master disk used in the nano-imprinting process had a pattern of chromium film on quartz glass. A pitch of the concentric circles was 80 nm and a width of the recessed parts was 40 nm. The surface of the master disk was coated with a release agent, Durasurf HD 1100, a product of Daikin Chemical Co. Ltd.

Subsequently, the original master disk of quartz was pushed uniformly against the resist film 31 of the substrate with a force of 3 kN for 60 seconds, and then was removed, to transfer the configuration of protrusions and recesses of the quartz master disk onto the resist 31 as shown in FIG. 1B. In order to remove the remaining films 32 of the resist material left at the recessed parts of the resist corresponding to the protruding parts of the original master disk, an etching process was conducted using CF4 gas, as shown in FIG. 1C.

Subsequently, the substrate under-process was introduced into a 5 wt % phosphoric acid solution for etching and the nano-holes 23 were expanded to a diameter of 10 nm, as shown in FIG. 1D. Subsequently, the expanded nano-holes 24 were filled with a magnetic material of a cobalt-based alloy by means of a plating method, as shown in FIG. 1E. After removing the resist material 31 by an etching process using the CF4 gas, the nano-holes that had been shielded with the resist material were sealed using a sodium silicate solution, as shown in FIG. 1F. Through the above-described procedure, a discrete track structure was fabricated, which alternately had recording track regions of magnetic material parts 22 and an inter-track region of a nonmagnetic material. After that, the substrate under-process was introduced into a CVD apparatus and diamond-like carbon was deposited. Then, the substrate under-process was extracted from the CVD apparatus and coated with a lubricant layer of perfluoropolyether formed using a dip-coating apparatus. Thus, a magnetic recording medium was obtained.

### Example 2

This example is based on the third aspect of embodiment, in which the resist material 31 is patterned by means of an electron beam drawing method, and is described referring to FIGS. 2A through 2 E.

A silicon substrate was used for a nonmagnetic substrate 10. After cleaning thoroughly, the substrate was introduced into a sputtering apparatus and an underlayer 11 composed of two layers was deposited. The first underlayer of a titanium film 50 nm thick was deposited and subsequently the second underlayer of a gold film 60 nm thick was deposited. Then, a magnetic recording layer 12 was formed as described in the following. First, an aluminum film 100 nm thick was deposited by a sputtering method. Subsequently, the substrate under-process was extracted from the sputtering apparatus and transferred into an anodizing apparatus. Anodization of the aluminum film was executed in an oxalic acid solution with a concentration of 0.3 molar % at an anodizing voltage of 2.5 V to form nano-holes 23 in a self-organizing manner. Through the anodization process, the metallic aluminum becomes an oxide, alumina. The formed nano-holes (FIG. 2A) had an interval of 12 nm and a diameter of 4 nm.

A resist material 31 for electron beam drawing was applied with a thickness of 100 nm on the alumina layer 21, and subsequently exposed to an electron beam in concentric circles, followed by a development process. A pitch of the concentric circles was 80 nm and a width of the recessed parts was 40 nm (FIG. 2B).

Subsequently, the substrate under-process was introduced into a 5 wt % phosphoric acid solution for etching and the nano-holes 23 were expanded to a diameter of 10 nm, as shown in FIG. 2C. Subsequently, the expanded nano-holes 24 were filled with a magnetic material of a cobalt-based alloy by means of a plating method, as shown in FIG. 2D. After removing the resist material 31 by an etching process using the CF4 gas, the nano-holes that had been shielded with the resist material were sealed using a sodium silicate solution, as shown in FIG. 2E. Through the above-described procedure, a discrete track structure was fabricated, which alternately had recording track regions of magnetic material parts 22 and an inter-track region of a nonmagnetic material. After that, the substrate under-process was introduced into a CVD apparatus and diamond-like carbon was deposited. Then, the substrate under-process was extracted from the CVD apparatus and coated with a lubricant layer of perfluoropolyether formed using a dip-coating apparatus. Thus, a magnetic recording medium was obtained.

It will be apparent to one skilled in the art that the manner of making and using the claimed invention has been adequately disclosed in the above-written description of the exemplary embodiments taken together with the drawings. Furthermore, the foregoing description of the embodiments according to the invention is provided for illustration only, and not for limiting the invention as defined by the appended claims and their equivalents.

It will be understood that the above description of the exemplary embodiments of the invention are susceptible to various modifications, changes and adaptations, and the same are intended to be comprehended within the meaning and range of equivalents of the appended claims.

What is claimed is:

1. A method of manufacturing a magnetic recording medium having a discrete track structure provided with a magnetic recording layer on a nonmagnetic substrate, the method comprising steps of
(a) forming an aluminum film on the nonmagnetic substrate;
(b) executing an anodizing process on the aluminum film while applying a voltage to form an alumina layer including nano-holes;
(c) applying a resist material on the alumina layer;
(d) removing the resist material on recording track regions of discrete tracks;
(e) depositing a magnetic material in the nano-holes in the recording track regions; and
(f) removing remaining resist material, the steps being conducted in this order.

2. The method of manufacturing a magnetic recording medium having a discrete track structure according to claim 1, further comprising a step of sealing exposed nano-holes after step (f).

3. The method of manufacturing a magnetic recording medium having a discrete track structure according to claim 1, further comprising, between step (a) and step (b), a step of forming recessed parts at positions of the nano-holes to be formed in step (b).

4. The method of manufacturing a magnetic recording medium having a discrete track structure according to claim 3, wherein the step of forming recessed parts at positions of the nano-holes to be formed in step (b) is carried out by a nano-imprinting method.

5. The method of manufacturing a magnetic recording medium having a discrete track structure according to claim 1, wherein step (d) includes a process of patterning the recording track regions by a nano-imprinting method.

6. The method of manufacturing a magnetic recording medium having a discrete track structure according to claim 1, wherein step (d) includes a process of patterning the recording track regions by an electron beam lithography method.

7. The method of manufacturing a magnetic recording medium having a discrete track structure according to claim 1, further comprising, before step (a), a step of forming a first underlayer comprising titanium and a second underlayer comprising gold on the nonmagnetic substrate, in this order.

8. A method comprising:
forming a film on a substrate;
processing the film to form a layer including nano-holes;
applying a resist material to the layer;
removing the resist material to expose nano-holes in a region to be used as a recording track region of a discrete track of a recording medium;
depositing a magnetic material in the exposed nano-holes; and
removing remaining resist material from the layer.

9. The method of claim 8, wherein the processing the film comprises anodizing the film while applying a voltage.

10. The method of claim 8, wherein the processing the film comprises imprinting the film with recesses corresponding to the nano-holes to be formed.

11. The method of claim 8, further comprising patterning the recording track region using nano-imprinting.

12. The method of claim 8, further comprising patterning the recording track region using electron beam lithography.

13. The method of claim 8, further comprising, before forming the film on the substrate, forming on the substrate a first underlayer comprising titanium and a second underlayer comprising gold.

14. A magnetic recording medium comprising:
a non-magnetic substrate;
an underlayer formed on the non-magnetic substrate; and
a magnetic recording layer formed on the underlayer, the magnetic recording layer including nano-holes corresponding to a recording track region of a discrete track of the magnetic recording medium;
wherein the nano-holes corresponding to a recording track region are filled with a magnetic material and separated from each other by a non-magnetic layer and sealed nano-holes.
